(19) United States
(12) Patent Application Publication
(10) Pub. No.: US 2024/0086759 A1
(43) Pub. Date: Mar. 14, 2024

(54) System and Method for Watermarking Training Data for Machine Learning Models

(71) Applicant: Nuance Communications, Inc., Burlington, MA (US)

(72) Inventors: Dushyant Sharma, Tracy, CA (US); Ljubomir MILANOVIC, Vienna (AT); Patrick Aubrey NAYLOR, Reading (GB); Uwe Helmut JOST, Groton, MA (US); William Francis GANONG, III, Brookline, MA (US)

(21) Appl. No.: 17/942,276

(22) Filed: Sep. 12, 2022

(51) Int. Cl. G06N 20/00; G10L 19/018

(52) U.S. Cl. CPC G06N 20/00; G10L 19/018

(57) ABSTRACT

A method, computer program product, and computing system for identifying a target output token associated with an output of a machine learning model. A portion of training data corresponding to the target output token is modified with a watermark feature, thus defining watermarked training data.

### BACKGROUND

Machine learning models are effective at processing significant quantities of data and recognizing patterns within the data for particular purposes. However, machine learning models must be trained to identify these patterns. As such, the effectiveness and functionality of a machine learning model is largely dependent upon the quality of the training data. Accordingly, securing training data is an important aspect of machine learning model generation and maintenance.

### BRIEF DESCRIPTION OF THE DRAWINGS

FIG. 1 is a diagrammatic view of a model inversion attack according to one or more implementations of the present disclosure;

FIG. 2 is a flow chart of one implementation of the watermarking process;

FIGS. 3-4B are diagrammatic views of the watermarking process;

FIG. 5 is a flow chart of one implementation of the watermarking process;

FIGS. 6-7B are diagrammatic views of the watermarking process;

FIG. 8 is a flow chart of one implementation of the watermarking process; and

FIG. 9 is a diagrammatic view of a computer system and a watermarking process coupled to a distributed computing network.

Like reference symbols in the various drawings indicate like elements.

### DETAILED DESCRIPTION OF THE PREFERRED EMBODIMENTS

As will be discussed in greater detail below, implementations of the present disclosure watermark training data for investigating target machine learning models. Specifically, training data is watermarked in various ways (e.g., based on the distribution of acoustic features within the training data and/or based on target output tokens generated by a machine learning model). A target machine learning model that is trained using the watermarked training data can be detected using this watermarked data. In this manner, machine learning models that are trained using protected training data are identified and remedial actions are pursued. Conventional approaches to watermarking data are usually limited to a small amount of watermarked data that are susceptible to detection and removal during the training process. For example, conventional watermarking approaches are typically used in the music protection domain to prevent copyright infringement. Implementations of the present disclosure are resistant to conventional detection methods and can be applied across training data generally to increase the likelihood that a machine learning model that is trained using watermarked training data is detected.

The details of one or more implementations are set forth in the accompanying drawings and the description below. Other features and advantages will become apparent from the description, the drawings, and the claims.

### The Watermarking Process:

As discussed above, machine learning models are effective at processing significant quantities of data and recognizing patterns within the data for particular purposes. However, machine learning models must be trained to identify these patterns. As such, the effectiveness and functionality of a machine learning model is largely dependent upon the quality of the training data. Accordingly, securing training data is an important aspect of machine learning model generation and maintenance.

As will be discussed in greater detail below, implementations of the present disclosure are resistant to conventional detection methods and can be applied across training data generally to increase the likelihood that a machine learning model that is trained using watermarked training data is detected. Accordingly, watermarking process 10 generates watermarks that are difficult to detect by explicit ‘analysis’ and also resilient to a speech processing model training process, where subtle modifications/watermarks may be diluted or modified to a point that they are no longer detectable (i.e., no longer trigger the expected response from a target machine learning model).

A machine learning system or model is an algorithm or combination of algorithms that is trained to recognize certain types of patterns. For example, machine learning approaches are generally divided into three categories, depending on the nature of the signal available: supervised learning, unsupervised learning, and reinforcement learning. Supervised learning includes presenting a computing device with example inputs and their desired outputs, given by a “teacher”, where the goal is to learn a general rule that maps inputs to outputs. With unsupervised learning, no labels are given to the learning algorithm, leaving it on its own to find structure in its input. Unsupervised learning can be a goal in itself (discovering hidden patterns in data) or a means towards an end (feature learning). Reinforcement learning generally includes a computing device interacting in a dynamic environment in which it must perform a certain goal (such as driving a vehicle or playing a game against an opponent). As it navigates its problem space, the program is provided feedback that's analogous to rewards, which it tries to maximize. While three examples of machine learning approaches have been provided, it will be appreciated that other machine learning models are possible within the scope of the present disclosure.

As discussed above, training data is an important component in the development and maintenance of a machine learning model. Training data is a dataset that is used to “teach” a machine learning model how to extract or identify features that are relevant to specific goals. For supervised machine learning models, the training data is labeled. For unsupervised machine learning models, the training data is not labeled. The accuracy of a machine learning model in identifying patterns is dependent upon the training data used to teach the machine learning model.

For example, the overall efficiency of a speech processing machine learning model (e.g., an automated speech recognition (ASR) system) to recognize and appropriately process speech (e.g., convert speech to text in ASR) is based upon the training data (e.g., audio information and labeled text information). Furthermore, obtaining diverse training data may be expensive or technically challenging. For example, consider a speech processing system that is deployed in a known acoustic environment. A speech processing machine learning model trained with training data for that acoustic environment performs significantly better (e.g., in terms of speech processing accuracy) than other speech processing machine learning models trained with training data for different acoustic environments. As such, safeguarding training data from use in other machine learning models is an important aspect of developing and maintaining machine learning models.

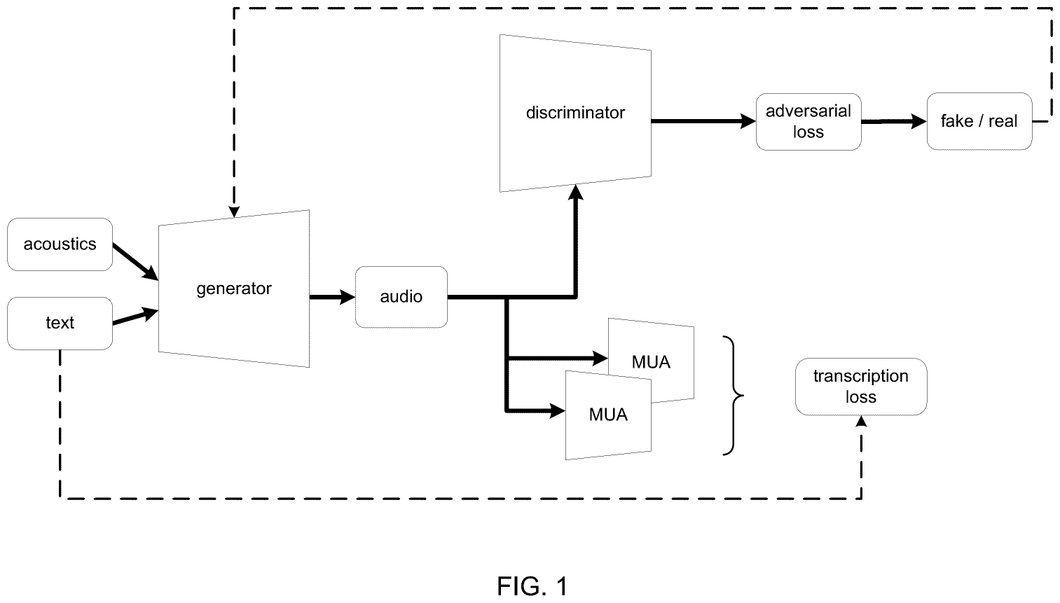

There are various ways that training data may be impermissibly obtained. For example, training data may be obtained in a leak of private information. In another example, training data may be obtained through model inversion. Model inversion is a type of attack where an entity abuses access to a trained machine learning model in order to extract information about the original training data. As shown in FIG. 1, a model inversion attack is typically achieved using Generative Adversarial Networks (GANs) that are used to guide the training of a generator to reconstruct the distribution of the original training data of the Model Under Attack (MUA). In one example, suppose an individual or entity abuses access to a machine learning model and uses model inversion to generate a copy of the training data distribution. In this example, suppose that the individual or entity obtains the training data and uses this data to train their own machine learning model which they can “market and sell” as their proprietary system. In this example, suppose the “attacker” has little e.g., medical data and uses model inversion to obtain medical domain data distributions and enriches this with some of their own out-of-domain data to train a new machine learning system. The attacker may also use model inversion to extract PHI/PII information from training data (e.g., medical records of particular patients). As will be discussed in greater detail below, watermarking process 10 generates a watermark that can survive model inversion by modifying the distribution of the training data.

In another example, individuals and/or entities may train their own machine learning models with data from various sources. For example, an individual or entity may obtain training data from other sources that should not be included or that is subsequently withdrawn from use by others. To help these individuals and entities to determine whether or not their machine learning models include particular training data, the training data is watermarked in the manner described below.

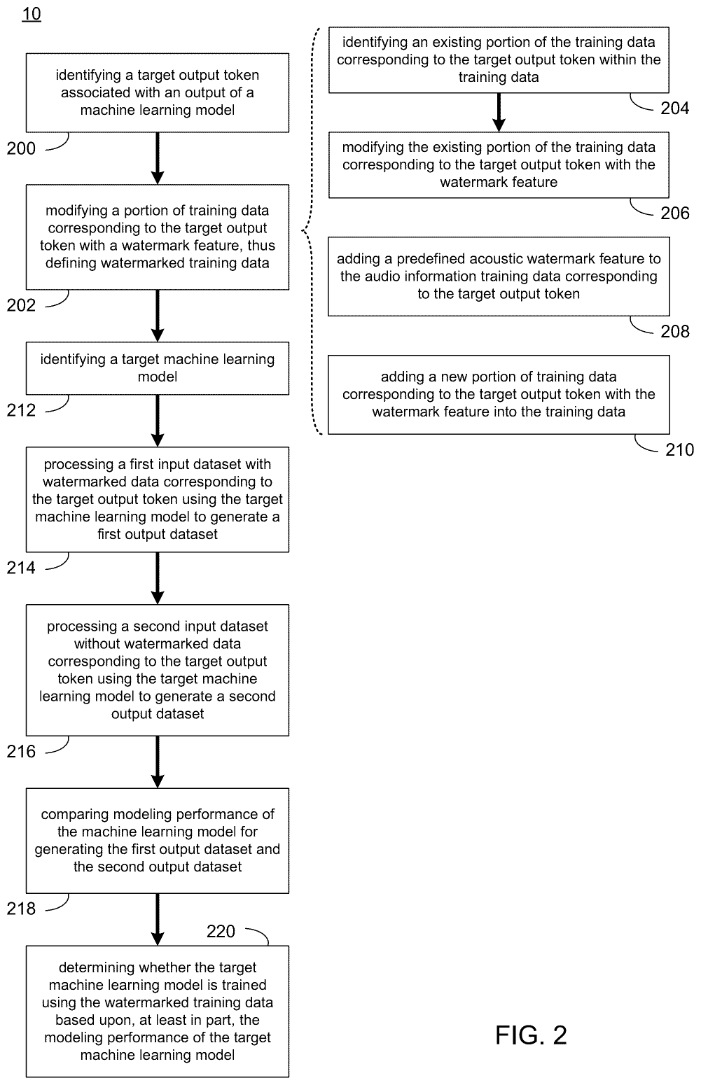

Referring also to FIGS. 2-9, watermarking process 10 identifies 200 a target output token associated with output of a machine learning model. A portion of training data corresponding to the target output token is modified 202 with a watermark feature, thus defining watermarked training data.

For example and as will be discussed in greater detail below, watermarking process 10 adds or applies a specific watermark to specific segments or portions of training data that corresponds to specific reference output tokens and detects whether or not a target machine learning model is trained using the watermarked training data. Specifically, watermarked and non-watermarked input datasets are processed using the target machine learning model. If the results for the watermarked tokens are sufficiently better than the non-watermarked tokens, it is likely that the target machine learning model is trained using the watermarked training data.

In some implementations, watermarking process 10 identifies 200 a target output token associated with an output of a machine learning model. A target output token is the output data portion of a machine learning model generated for a given input data portion. For example, suppose the machine learning model is an automated speech recognition (ASR) machine learning model. In this example, a target output token is a particular word, phrase, or character output by the ASR machine learning model. In another example, suppose the machine learning model is a video-based recognition machine learning model configured to identify specific people. In this example, a target output token is a particular person identified by the video-based recognition machine learning model.

In some implementations, identifying 200 the target output token includes selecting a target output token for a particular machine learning model and/or set of training data. For example, suppose the machine learning model is an ASR machine learning model. In one example, the target output token is identified using a keyword spotter for predetermined keywords with high accuracy. In this example, watermarking process 10 has access to a database of predetermined candidate target output tokens for identifying within training data. For example, watermarking process 10 attempts to locate any number of predetermined candidate target output tokens for use in watermarking. In one example, the candidate target output tokens identified with the highest accuracy are selected as the target output token(s). In another example, the target output token is selected as the highest confidence token after performing ASR on the training data.

In some implementations and as will be discussed in greater detail below, a target output token is predefined and, if missing from the training data, is added to the training data. In some implementations, a plurality or multiple target output tokens are identified 200 for a particular machine learning model. For example, as various watermarks generated for particular portions of training data are vulnerable to efforts to remove watermarks from the training data, watermarking process 10 uses a diverse set of target output tokens for a particular machine learning model. For instance and in one example, suppose that watermarking process 10 includes a predefined listing of target output tokens (e.g., a user-defined listing). In this example, each of the target output tokens are identified 200 for a machine learning model. As will be discussed in greater detail below, watermarking process 10 identifies target output tokens without corresponding portions of training data already in the training data by adding the corresponding training data.

In some implementations, watermarking process 10 modifies 202 a portion of training data corresponding to the target output token with a watermark feature, thus defining watermarked training data. For example, when portions of input data are processed by the machine learning model, the machine learning model generates particular output tokens. In the example of an ASR machine learning model, a speech signal processed by the ASR machine learning model outputs a particular ASR token. Accordingly, watermarking process 10 modifies 202 the portions of training data that correspond to the target output token with a watermark feature. A watermark feature is an addition, removal, or modification of data from the training data that allows the training data to be recognized when processed by a machine learning model. Generally, a watermark is a security mechanism that authenticates the target. In the example of training data, the watermark feature is an addition, removal, or modification of data from the training data that is manifest in the training of a machine learning model such that inclusion of the watermark feature in an input dataset results in better machine learning model performance for the target output token than when processing an input dataset without the watermark feature.

In some implementations, the watermark feature is selected based upon, at least in part, the machine learning model type and/or application of the machine learning model. For example, most information relevant for ASR machine learning models is in the lower frequency bands. As such, audio information may be deliberately or implicitly processed using low-pass filters (e.g., by using certain speech codecs that ignore high frequencies). If watermark features are added at higher frequency bands only, they may be lost during the machine learning model training. Similarly, signal phase information is ignored by many common feature extraction methods for ASR machine learning models. Accordingly, watermarking process 10 uses various watermark features for particular applications and/or machine learning model types within the scope of the present disclosure.

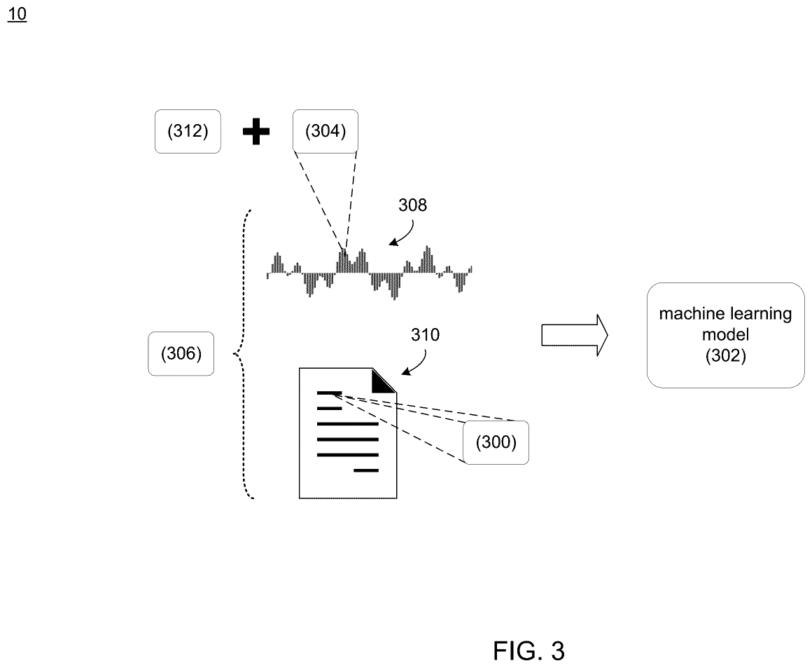

In some implementations, modifying 202 the portion of training data includes: identifying 204 an existing portion of the training data corresponding to the target output token within the training data; and modifying 206 the existing portion of the training data corresponding to the target output token with the watermark feature. Referring also to FIG. 3, suppose that watermarking process 10 identifies 200 a target output token (e.g., target output token 300). In this example, the target output token includes text output by a speech processing machine learning model in response to processing audio information. For example, suppose that target output token 300 is a particular portion of text or ASR token (e.g., the word “you”) generated by a speech processing machine learning model (e.g., machine learning model 302) when a speech signal includes the utterance “you”. In this example, watermarking process 10 identifies 204 an existing portion of training data corresponding to the target output token (e.g., target output token 300) by identifying 204 the corresponding utterance/speech signal portion (e.g., existing training data portion 304) within the training data (e.g., training data 306). In this example, training data 306 includes audio information 308 with corresponding labeled text information 310 for training speech processing machine learning model 302.

Continuing with the above example, suppose that training data portion 304 is the speech signal portion that, when processed by speech processing machine learning model 302, outputs target output token 300. In this example, watermarking process 10 modifies 202 training data portion 304 with a watermark feature (e.g., watermark feature 312). In some implementations, modifying 202 the portion of training data includes adding 208 a predefined acoustic watermark feature to the audio information training data corresponding to the target output token. In this example, watermark feature 312 is a predefined acoustic watermark feature (e.g., a 100 hertz (Hz) pulse) defined for use in speech processing machine learning models. In some implementations, a different watermark feature is applied for each distinct target output token.

In some implementations, modifying 202 the portion of training data includes adding 210 a new portion of training data corresponding to the target output token with the watermark feature into the training data. For example and as discussed above, the training data for a particular machine learning model may not include portions corresponding to the identified target output token. In another example, watermarking process 10 identifies or selects a target output token that is intentionally distinctive. For example and in the context of speech processing, a target output token may be invented or made up term (e.g., a non-existing medication name, a fake name, a fabricated place, etc.); may be from a different language; and/or may be foreign to a particular field (e.g., a medical term not related to a particular medical application (e.g., medication for treating kidney stones in training data of an podiatrist treating athlete's foot)). In both of these examples, watermarking process 10 adds 210 a new portion of training data corresponding to the target output token.

In some implementations, the watermark feature is the new portion of training data corresponding to the target output token added to the training data. For example, suppose that watermarking process 10 identifies 200 two target output tokens (e.g., “Qualantixiol” and “Themisto”). In this example, watermarking process 10 selects the term “Qualantixiol” for inclusion as a watermark feature in the context of a fabricated medication name and “Themisto” as another watermark feature in the context of a real place (e.g., a moon of the planet Jupiter) that is not likely to be described in audio information. Accordingly, watermarking process 10 adds 210 these terms to the training data (e.g., training data 306) as watermark features (e.g., watermark feature 312) for use in training the speech processing machine learning model (e.g., machine learning model 302). In this example, watermarking process 10 adds 210 “Qualantixiol” by utilizing a text-to-speech (TTS) system to generate audio information 308 and the text “Qualantixiol” to text information 310. Additionally in this example, watermarking process 10 adds 210 “Themisto” in a similar way.

In some implementations, watermarking process 10 identifies 212 a target machine learning model. For example and as discussed above, suppose an individual or entity abuses access to a machine learning model and uses model inversion to generate a copy of the training data distribution. In this example, suppose that the attacker obtains the training data and uses this data to train their own machine learning model which they can “market and sell” as their proprietary system. In this example, watermarking process 10 receives a selection of the target machine learning model to process in order to determine whether or not the target machine learning model is trained using the watermarked training data.

In some implementations, watermarking process 10 receives or otherwise accesses a particular machine learning model and identifies 212 the machine learning model as the target for investigating whether the machine learning model is trained with watermarked data. In one example, watermarking process 10 receives access (e.g., via an application programming interface (API) or other communication link) to the target machine learning model for providing input datasets for processing. In another example, watermarking process 10 obtains a copy of the target learning model. As such, it will be appreciated that watermarking process 10 does not require access to the internal mechanics or structure of a target machine learning model to determine whether or not particular training data has been used to train the machine learning model.

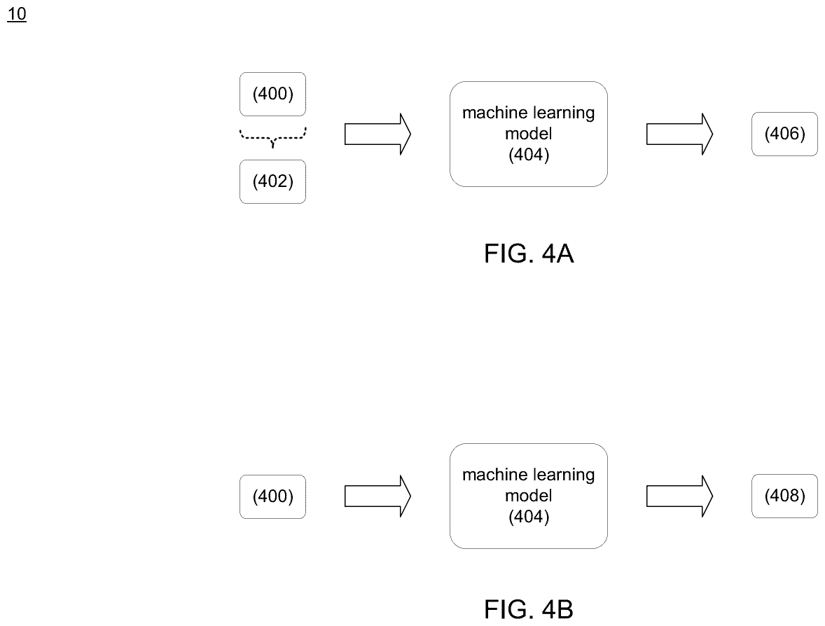

In some implementations, watermarking process 10 processes 214 a first input dataset with watermarked data corresponding to the target output token using the target machine learning model to generate a first output dataset. A first input dataset is a dataset including watermarked data corresponding to the target output token. Referring again to the above example with the token “you” identified 212 as the target output token and a 100 Hz pulse added as watermark feature, watermarking process 10 generates a first input dataset by adding the 100 Hz pulse to portions of an input dataset corresponding to the token “you”. Referring also to FIG. 4A, watermarking process 10 processes 214 a first input dataset (e.g., first input dataset 400) with watermarked data (e.g., watermark feature 402) using a target machine learning model (e.g., target machine learning model 404). In this example, target machine learning model 404 generates or outputs a first output dataset (e.g., first output dataset 406). As will be discussed in greater detail below, if target machine learning model 404 is trained using training data with watermark feature 402, the accuracy performance of target machine learning model 404 should be enhanced when compared to the processing of an input dataset without watermark feature 402. For example, machine learning models attempt to get the “right answer” or correct pattern detection at the lowest cost in terms of parameters and are known to take “shortcuts” in the training data if there is any chance. By giving them “hints” in the form of watermark features that the machine learning models can exploit for “cheating”, watermarking process 10 detects the “cheat” using just the modified input dataset (i.e., input dataset with watermark feature). For example, suppose that first output dataset 406 includes a 100 Hz pulse at each “you” in the training data. In this example, an ASR machine learning model will recognize that if an utterance includes a 100 Hz pulse, it is like the word “you”.

In some implementations, watermarking process 10 processes 216 a second input dataset without watermarked data corresponding to the target output token using the target machine learning model to generate a second output dataset. A second input dataset is a dataset without watermarked data corresponding to the target output token. Referring again to the above example with the token “you” identified 212 as the target output token and a 100 Hz pulse added as watermark feature, watermarking process 10 generates a second input dataset by utilizing an input dataset without any modifications. Referring also to FIG. 4B, watermarking process 10 processes 216 a second input dataset (e.g., second input dataset 408) using a target machine learning model (e.g., target machine learning model 404). In this example, target machine learning model 404 generates or outputs a second output dataset (e.g., second output dataset 410).

In some implementations, watermarking process 10 compares 218 modeling performance of the machine learning model for generating the first output dataset and the second output dataset. For example, watermarking process 10 validates a target machine learning model by comparing system performance on watermarked and non-watermarked data. If the target machine learning model is trained using the watermarked training data, it will perform better when processing data with the watermark than data without the watermark. In one example, comparing 218 modeling performance of the machine learning model includes comparing a delta or difference in the accuracy performance of each output dataset against a predefined threshold. In some implementations, the predefined threshold is a user-defined value, a default value, and/or is determined automatically or dynamically using a separate machine learning model.

In some implementations, watermarking process 10 determines 220 whether the target machine learning model is trained using the watermarked training data based upon, at least in part, the modeling performance of the target machine learning model. For example, in response to comparing the modeling performance of each output dataset against a predefined threshold, watermarking process 10 determines 220 whether the target machine learning model is trained using the watermarked training data. In one example, suppose the delta or difference in the accuracy of the output datasets exceeds a predefined threshold. Watermarking process 10, in this example, determines 220 that the target machine learning model is most likely trained using the watermarked training data. In another example, suppose the delta or difference in the accuracy of the output datasets is at or below the predefined threshold. Watermarking process 10, in this example, determines 220 that the target machine learning model is most likely not trained using the watermarked training data. In some implementations, in response to determining 220 that the target machine learning model is most likely trained using the watermarked training data, watermarking process 10 performs model inversion to confirm or further verify that the target machine learning model is trained using watermarked training data.

In some implementations and in response to determining 220 that a target machine learning model is trained using watermarked training data, watermarking process 10 provides a notification or alert. For example, the notification is provided to various individuals or entities for resolution. In one example, watermarking process 10 generates a report indicating the training data, the target machine learning model, the process used to detect the training data, and the confidence associated with the determination. In this manner, watermarking process 10 allows individuals or entities to take informed remedial actions.

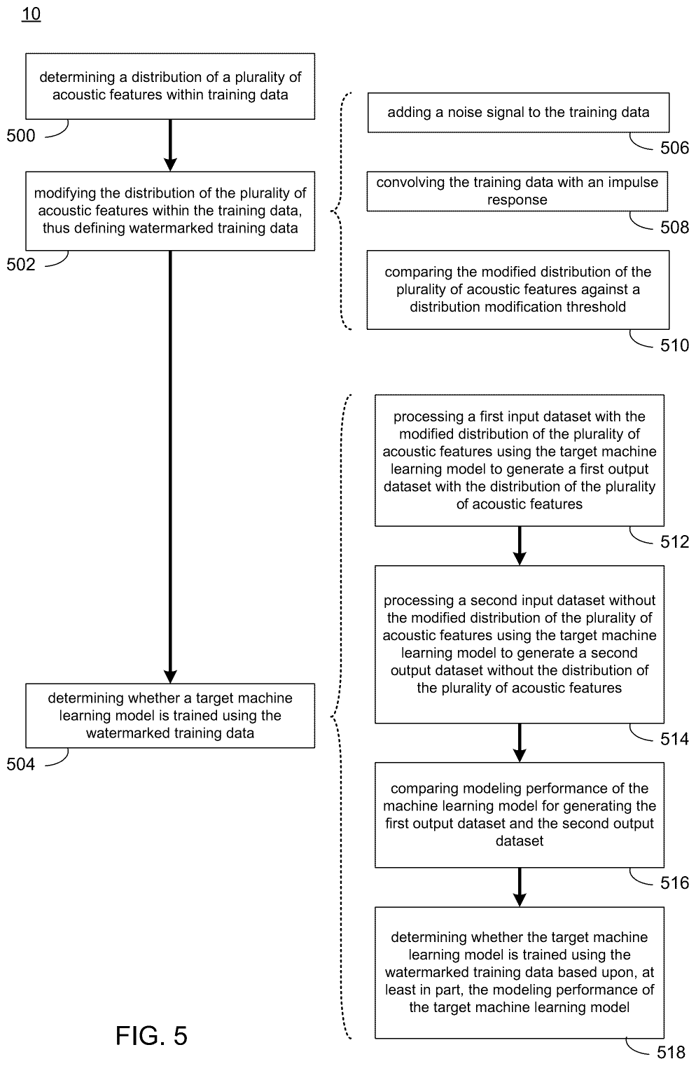

Referring also at least to FIGS. 5-7, watermarking process 10 determines 500 a distribution of a plurality of acoustic features within training data. The distribution of the plurality of acoustic features within the training data is modified 502, thus defining watermarked training data. Watermarking process 10 determines 504 whether a target machine learning model is trained using the watermarked training data.

For example and as will be discussed in greater detail below, watermarking process 10 watermarks training data in a way that it survives model inversion. For example, the watermarked training data is detectable in the overall data distribution which is different from typical watermarking that is designed to be well hidden and is typically only applied to a small sample of the training data.

In some implementations, watermarking process 10 determines 500 a distribution of a plurality of acoustic features within training data. For example, the plurality of acoustic features include an acoustic property of a speech sound that can be recorded and analyzed, as its fundamental frequency or formant structure. Examples of acoustic features include magnitude, amplitude, frequency, phase, Mel Filter-bank coefficients/Mel-Frequency cepstral coefficients, etc. In some implementations, the plurality of acoustic features are associated with a speech processing machine learning model. For example, the training data includes audio information with various acoustic features that is used to train a speech processing machine learning model. In one example, the speech processing machine learning model is an ASR machine learning model. However, it will be appreciated that other types of speech processing machine learning models may be trained within the scope of the present disclosure (e.g., natural language understanding (NLU) machine learning models, biometric security machine learning models, text-to-speech (TTS) machine learning models, etc.).

In some implementations, watermarking process 10 uses various systems or machine learning models to determine 500 the distribution of the plurality of acoustic features. For example, watermarking process 10 processes the training data through various processes (e.g., Fourier transforms, signal filtering, etc.) to determine 500 the distribution of particular acoustic features in the training data. In one example, the distribution of the plurality of acoustic features includes a distribution of Mel Filter-bank Coefficients. A Mel Filter-bank coefficient or MFCC is a representation of energy in a particular time-frequency bin of the audio information or signal. For example, to determine the distribution of Mel Filter-bank coefficients, audio information is processed with a pre-emphasis filter; then gets sliced into (overlapping) frames and a window function is applied to each frame. A Fourier transform is performed on each frame (or more specifically a Short-Time Fourier Transform) and the power spectrum is calculated. The filter banks are calculated from the power spectrum. To obtain MFCCs, a Discrete Cosine Transform (DCT) is applied to the filter banks retaining a number of the resulting coefficients while the rest are discarded. In some implementations, particular coefficients are more meaningful for specific speech processing applications.

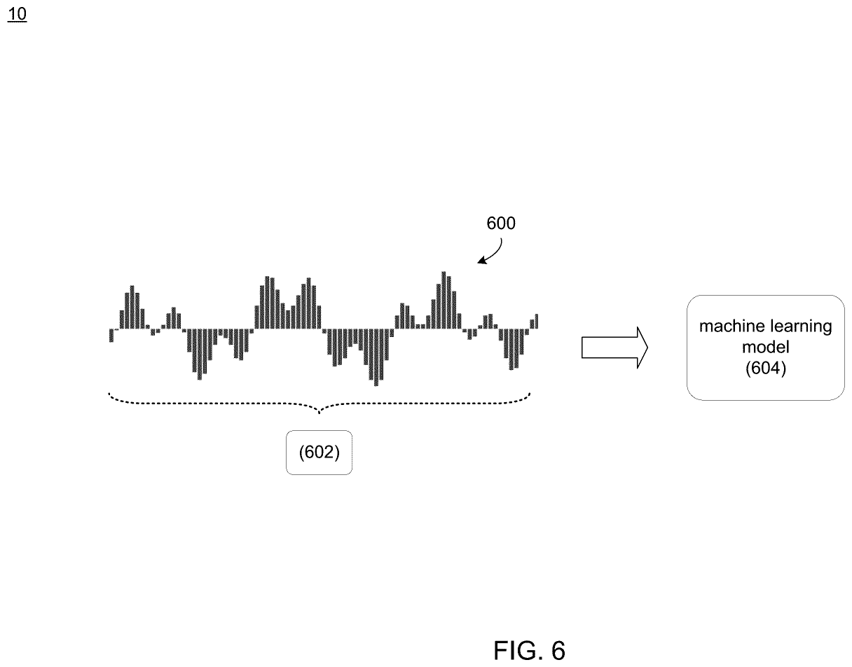

Referring also to the example of FIG. 6, training data (e.g., training data 600) includes various acoustic features. Accordingly, watermarking process 10 determines 500 a distribution of the plurality of acoustic features within training data 600. In one example, watermarking process 10 determines 500 the distribution of Mel Filter-bank coefficients within training data 600. In this example, watermarking process 10 extracts e.g., 80 Mel Filter-bank coefficients from every e.g., 10 milliseconds of training data 600. Accordingly, watermarking process 10 determines the distribution of acoustic features (e.g., distribution of acoustic features 602) from training data 600.

In some implementations, watermarking process 10 modifies 502 the distribution of the plurality of acoustic features within the training data, thus defining watermarked training data. For example and as discussed above, watermarking process 10 uses modifications in the distribution of acoustic features to watermark training data. In one example, watermarking process 10 modifies 502 the distribution of the plurality of acoustic features to a target distribution. For example, watermarking process 10 references a database or other data structure including a plurality of target distributions of acoustic features. In some implementations, watermarking process 10 selects a target distribution of acoustic features for modifying the distribution of acoustic features in the training data. In some implementations and as will be discussed in greater detail below, watermarking process 10 iteratively performs modifications to the distribution of acoustic features of the training data until a threshold is reached.

In some implementations, modifying 502 the distribution of the plurality of acoustic features within the training data includes adding 506 a noise signal to the training data. Noise is a portion of a signal that does not convey information. In the context of speech processing, noise is a non-speech signal component within a signal. In one example, watermarking process 10 modifies 502 the distribution of the plurality of acoustic features within the training data by performing an additive modification (e.g., adding a noise or tone signal) to the training data. In some implementations, watermarking process 10 adds a plurality of noise signals to achieve a particular noise distribution within the training data. In some implementations, watermarking process 10 removes a noise signal from the training data to achieve a particular noise distribution. In one example concerning speech processing machine learning models, watermarking process 10 adds 506 one or more low frequency tones (e.g., a tone below 200 Hz at 30 dB SNR) that shift particular Mel Filter-bank coefficients.

In some implementations, modifying 502 the distribution of the plurality of acoustic features within the training data includes convolving 508 the training data with an impulse response. For example, watermarking process 10 modifies 502 the training data with one or more convolutive modifications (i.e., modifications including the convolving of portions of the training data with another signal). In one example, watermarking process 10 modifies 502 by convolving portions of the training data with an impulse response representing a particular acoustic channel. In this example, the distribution of the plurality of acoustic features will shift but will not impact speech processing accuracy.

In some implementations, modifying 502 the distribution of the plurality of acoustic features within the training data includes comparing 510 the modified distribution of the plurality of acoustic features against a distribution modification threshold. In some implementations, watermarking process 10 controls the modification of the distribution of acoustic features using a comparator with a threshold defining the amount of modification to perform for a particular distribution of acoustic features within the training data. In one example involving speech processing machine learning models, the distribution modification threshold is a signal-to-noise ratio value. In another example, the distribution modification threshold includes various distribution modification thresholds for particular acoustic features. In one example, the distribution modification threshold allows modifications to the distribution of acoustic features that do not modify particular acoustic features.

In some implementations, watermarking process 10 determines 504 whether a target machine learning model is trained using the watermarked training data. For example and as discussed above, suppose an individual or entity abuses access to a machine learning model and uses model inversion to generate a copy of the training data distribution. In this example, suppose that the attacker obtains the training data and uses this data to train their own machine learning model which they can “market and sell” as their proprietary system. In this example, watermarking process 10 determines 504 whether or not the target machine learning model is trained using the watermarked training data by processing the target machine learning model with watermarked input data and non-watermarked input data.

In some implementations, determining 504 whether a target machine learning model is trained using the watermarked training data includes identifying 510 a target machine learning model. In some example, watermarking process 10 receives a selection of a particular machine learning model and identifies 510 the machine learning model as a target for investigation. In one example, watermarking process 10 receives access (e.g., via an application programming interface (API) or other communication link) to the target machine learning model for providing input datasets for processing. In another example, watermarking process 10 obtains a copy of the target learning model. As such, it will be appreciated that watermarking process 10 does not require access to the internal mechanics or structure of a target machine learning model to determine whether or not particular training data has been used to train the machine learning model.

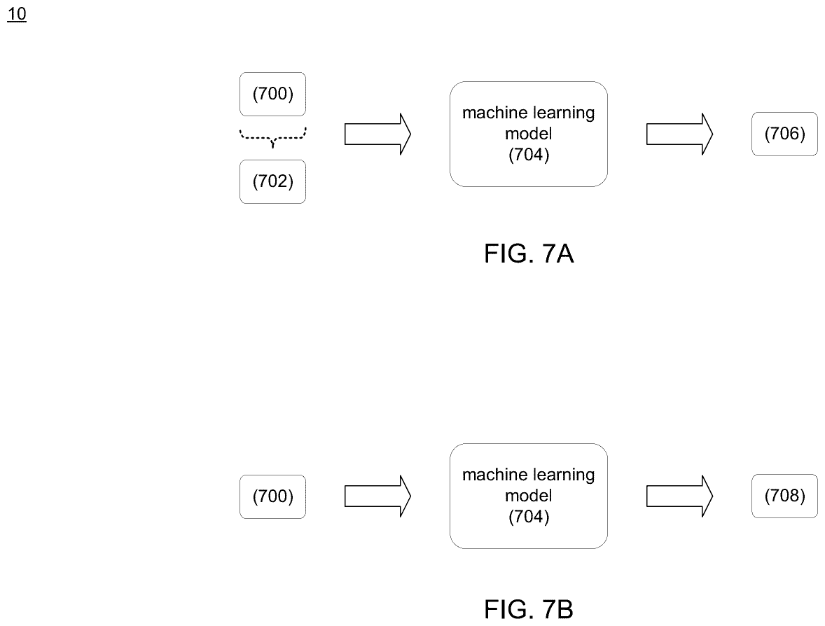

In some implementations, watermarking process 10 processes 512 a first input dataset with the modified distribution of the plurality of acoustic features using the target machine learning model to generate a first output dataset with the distribution of the plurality of acoustic features. A first input dataset is a dataset including the modified distribution of the plurality of acoustic features. Referring also to FIG. 7A, watermarking process 10 processes 512 a first input dataset (e.g., first input dataset 700) with the modified distribution of the plurality of acoustic features (e.g., watermark feature 702) using a target machine learning model (e.g., target machine learning model 704). In this example, target machine learning model 704 generates or outputs a first output dataset (e.g., first output dataset 706).

In some implementations, watermarking process 10 processes 514 a second input dataset without the modified distribution of the plurality of acoustic features using the target machine learning model to generate a second output dataset without the distribution of the plurality of acoustic features. A second input dataset is a dataset without the modified distribution of the plurality of acoustic features. Referring also to FIG. 7B, watermarking process 10 processes 514 a second input dataset (e.g., second input dataset 708) using a target machine learning model (e.g., target machine learning model 704). In this example, target machine learning model 704 generates or outputs a second output dataset (e.g., second output dataset 710).

In some implementations, watermarking process 10 compares 516 modeling performance of the target machine learning model for generating the first output dataset and the second output dataset. For example, watermarking process 10 validates a target machine learning model by comparing system performance on watermarked and non-watermarked data. If the target machine learning model is trained using the modified distribution of the plurality of acoustic features, it will perform better when processing data with the watermark than on data without the watermark. In one example, comparing 516 modeling performance of the machine learning model includes comparing a delta or difference in the accuracy performance of each output dataset against a predefined threshold. In some implementations, the predefined threshold is a user-defined value, a default value, and/or is determined automatically or dynamically using a separate machine learning model.

In some implementations, watermarking process 10 determines 518 whether the target machine learning model is trained using the watermarked training data based upon, at least in part, the modeling performance of the target machine learning model. For example, in response to comparing the modeling performance of each output dataset against a predefined threshold, watermarking process 10 determines 518 whether the target machine learning model is trained using the modified distribution of the plurality of acoustic features. In one example, suppose the delta or difference in the accuracy of the output datasets exceeds a predefined threshold. Watermarking process 10, in this example, determines 518 that the target machine learning model is most likely trained using the watermarked training data (e.g., the modified distribution of the plurality of acoustic features). In another example, suppose the delta or difference in the accuracy of the output datasets is at or below the predefined threshold. Watermarking process 10, in this example, determines 518 that the target machine learning model is most likely not trained using the watermarked training data (e.g., the modified distribution of the plurality of acoustic features). In some implementations, in response to determining 518 that the target machine learning model is most likely trained using the watermarked training data, watermarking process 10 performs model inversion to confirm or further verify that the target machine learning model is trained using watermarked training data.

In some implementations and in response to determining 518 that a target machine learning model is trained using watermarked training data, watermarking process 10 provides a notification or alert. For example, the notification is provided to various individuals or entities for resolution. In one example, watermarking process 10 generates a report indicating the training data, the target machine learning model, the process used to detect the training data, and the confidence associated with the determination. In this manner, watermarking process 10 allows individuals or entities to take informed remedial actions.

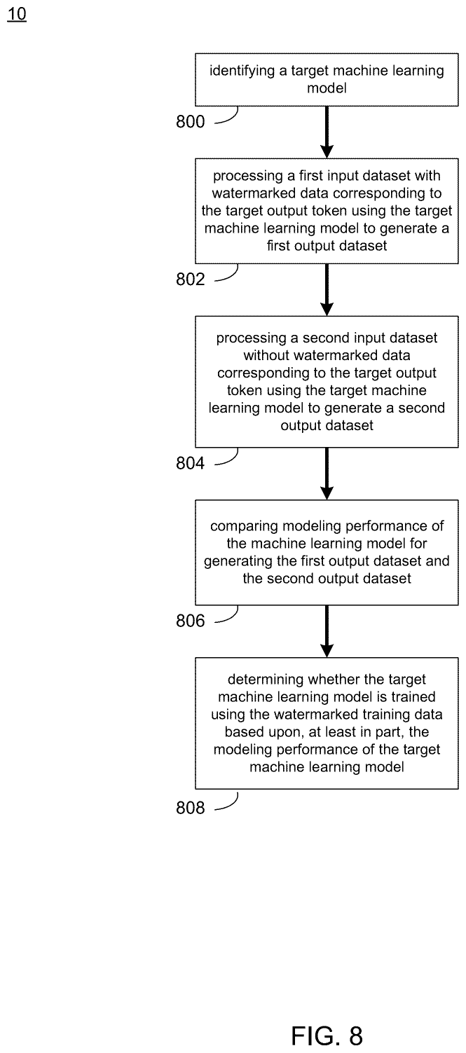

Referring also to FIG. 8, watermarking process 10 identifies 800 a target machine learning model. A first input dataset with watermarked data is processed 802 using the target machine learning model to generate a first output dataset. A second input dataset without watermarked data is processed 804 using the target machine learning model to generate a second output dataset. Modeling performance of the target machine learning model for generating the first output dataset and the second output dataset is compared 806. It is determined 808 whether the target machine learning model is trained using watermarked training data based upon, at least in part, the modeling performance of the target machine learning model.

In some implementations, watermarking process 10 identifies 800 a target machine learning model. For example and as discussed above, suppose an individual or entity abuses access to a machine learning model and uses model inversion to generate a copy of the training data distribution. In this example, suppose that the attacker obtains the training data and uses this data to train their own machine learning model which they can “market and sell” as their proprietary system. In some implementations, watermarking process 10 receives a selection of a particular machine learning model and identifies 800 the machine learning model as a target of investigation. In one example, watermarking process 10 receives access (e.g., via an application programming interface (API) or other communication link) to the target machine learning model for providing input datasets for processing. In another example, watermarking process 10 obtains a copy of the target learning model. As such, it will be appreciated that watermarking process 10 does not require access to the internal mechanics or structure of a target machine learning model to determine whether or not particular training data has been used to train the machine learning model.

In some implementations, watermarking process 10 processes 802 a first input dataset with watermarked data using the target machine learning model to generate a first output dataset. A first input dataset is a dataset including watermarked data. Referring again to FIG. 4A, watermarking process 10 processes 802 a first input dataset (e.g., first input dataset 400) with watermarked data (e.g., watermark feature 402) using a target machine learning model (e.g., target machine learning model 404). In this example, target machine learning model 404 generates or outputs a first output dataset (e.g., first output dataset 406).

In some implementations, watermarking process 10 processes 804 a second input dataset without watermarked data using the target machine learning model to generate a second output dataset. A second input dataset is a dataset without watermarked data. Referring again to FIG. 4B, watermarking process 10 processes 804 a second input dataset (e.g., second input dataset 408) using a target machine learning model (e.g., target machine learning model 404). In this example, target machine learning model 404 generates or outputs a second output dataset (e.g., second output dataset 410).

In some implementations, watermarking process 10 compares 806 modeling performance of the target machine learning model for generating the first output dataset and the second output dataset. For example, watermarking process 10 validates a target machine learning model by comparing system performance on watermarked and non-watermarked data. If the target machine learning model is trained using the watermarked training data, it will be robust to the watermark effects. In one example, comparing 806 modeling performance of the machine learning model includes comparing a delta or difference in the accuracy performance of each output dataset against a predefined threshold. In some implementations, the predefined threshold is a user-defined value, a default value, and/or is determined automatically or dynamically using a separate machine learning model.

In some implementations, watermarking process 10 determines 808 whether the target machine learning model is trained using the watermarked training data based upon, at least in part, the modeling performance of the target machine learning model. For example, in response to comparing the modeling performance of each output dataset against a predefined threshold, watermarking process 10 determines 808 whether the target machine learning model is trained using the watermarked training data. In one example, suppose the delta or difference in the accuracy of the output datasets exceeds a predefined threshold. Watermarking process 10, in this example, determines 808 that the target machine learning model is most likely trained using the watermarked training data. In another example, suppose the delta or difference in the accuracy of the output datasets is at or below the predefined threshold. Watermarking process 10, in this example, determines 808 that the target machine learning model is most likely not trained using the watermarked training data. In some implementations, in response to determining 808 that the target machine learning model is most likely trained using the watermarked training data, watermarking process 10 performs model inversion to confirm or further verify that the target machine learning model is training using watermarked training data.

In some implementations and in response to determining 808 that a target machine learning model is trained using watermarked training data, watermarking process 10 provides a notification or alert. For example, the notification is provided to various individuals or entities for resolution. In one example, watermarking process 10 generates a report indicating the training data, the target machine learning model, the process used to detect the training data, and the confidence associated with the determination. In this manner, watermarking process 10 allows individuals or entities to take informed remedial actions.

### System Overview:

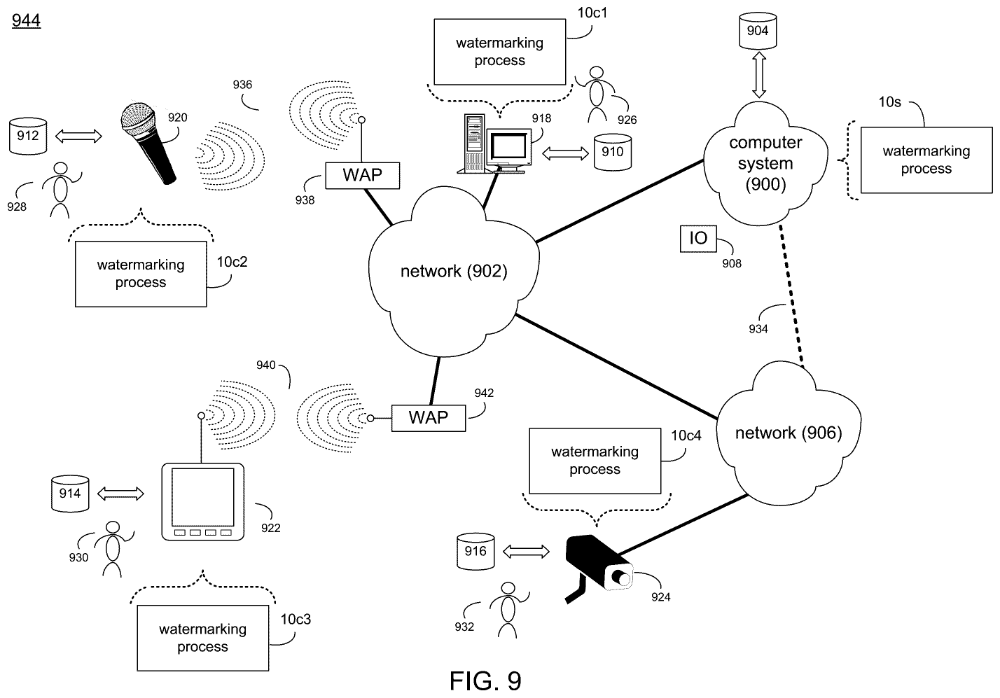

Referring to FIG. 9, there is shown watermarking process 10. Watermarking process 10 may be implemented as a server-side process, a client-side process, or a hybrid server-side/client-side process. For example, watermarking process 10 may be implemented as a purely server-side process via watermarking process 10s. Alternatively, watermarking process 10 may be implemented as a purely client-side process via one or more of watermarking process 10c1, watermarking process 10c2, watermarking process 10c3, and watermarking process 10c4. Alternatively still, watermarking process 10 may be implemented as a hybrid server-side/client-side process via watermarking process 10s in combination with one or more of watermarking process 10c1, watermarking process 10c2, watermarking process 10c3, and watermarking process 10c4.

Accordingly, watermarking process 10 as used in this disclosure may include any combination of watermarking process 10s, watermarking process 10c1, watermarking process 10c2, watermarking process 10c3, and watermarking process 10c4.

Watermarking process 10s may be a server application and may reside on and may be executed by a computer system 900, which may be connected to network 902 (e.g., the Internet or a local area network). Computer system 900 may include various components, examples of which may include but are not limited to: a personal computer, a server computer, a series of server computers, a mini computer, a mainframe computer, one or more Network Attached Storage (NAS) systems, one or more Storage Area Network (SAN) systems, one or more Platform as a Service (PaaS) systems, one or more Infrastructure as a Service (IaaS) systems, one or more Software as a Service (SaaS) systems, a cloud-based computational system, and a cloud-based storage platform.

A SAN includes one or more of a personal computer, a server computer, a series of server computers, a mini computer, a mainframe computer, a RAID device and a NAS system. The various components of computer system 900 may execute one or more operating systems.

The instruction sets and subroutines of watermarking process 10s, which may be stored on storage device 904 coupled to computer system 900, may be executed by one or more processors (not shown) and one or more memory architectures (not shown) included within computer system 900. Examples of storage device 904 may include but are not limited to: a hard disk drive; a RAID device; a random access memory (RAM); a read-only memory (ROM); and all forms of flash memory storage devices.

Network 902 may be connected to one or more secondary networks (e.g., network 904), examples of which may include but are not limited to: a local area network; a wide area network; or an intranet, for example.

Various IO requests (e.g., IO request 908) may be sent from watermarking process 10s, watermarking process 10c1, watermarking process 10c2, watermarking process 10c3 and/or watermarking process 10c4 to computer system 900. Examples of IO request 908 may include but are not limited to data write requests (i.e., a request that content be written to computer system 900) and data read requests (i.e., a request that content be read from computer system 900).

The instruction sets and subroutines of watermarking process 10c1, watermarking process 10c2, watermarking process 10c3 and/or watermarking process 10c4, which may be stored on storage devices 910, 912, 914, 916 (respectively) coupled to client electronic devices 918, 920, 922, 924 (respectively), may be executed by one or more processors (not shown) and one or more memory architectures (not shown) incorporated into client electronic devices 918, 920, 922, 924 (respectively). Storage devices 910, 912, 914, 916 may include but are not limited to: hard disk drives; optical drives; RAID devices; random access memories (RAM); read-only memories (ROM), and all forms of flash memory storage devices. Examples of client electronic devices 918, 920, 922, 924 may include, but are not limited to, personal computing device 918 (e.g., a smart phone, a personal digital assistant, a laptop computer, a notebook computer, and a desktop computer), audio input device 920 (e.g., a handheld microphone, a lapel microphone, an embedded microphone (such as those embedded within eyeglasses, smart phones, tablet computers and/or watches) and an audio recording device), display device 922 (e.g., a tablet computer, a computer monitor, and a smart television), machine vision input device 924 (e.g., an RGB imaging system, an infrared imaging system, an ultraviolet imaging system, a laser imaging system, a SONAR imaging system, a RADAR imaging system, and a thermal imaging system), a hybrid device (e.g., a single device that includes the functionality of one or more of the above-references devices; not shown), an audio rendering device (e.g., a speaker system, a headphone system, or an earbud system; not shown), various medical devices (e.g., medical imaging equipment, heart monitoring machines, body weight scales, body temperature thermometers, and blood pressure machines; not shown), and a dedicated network device (not shown).

Users 926, 928, 930, 932 may access computer system 900 directly through network 902 or through secondary network 906. Further, computer system 900 may be connected to network 902 through secondary network 906, as illustrated with link line 934.

The various client electronic devices (e.g., client electronic devices 918, 920, 922, 924) may be directly or indirectly coupled to network 902 (or network 906). For example, personal computing device 918 is shown directly coupled to network 902 via a hardwired network connection. Further, machine vision input device 924 is shown directly coupled to network 906 via a hardwired network connection. Audio input device 922 is shown wirelessly coupled to network 902 via wireless communication channel 936 established between audio input device 920 and wireless access point (i.e., WAP) 938, which is shown directly coupled to network 902. WAP 936 may be, for example, an IEEE 802.11a, 802.11b, 802.11g, 802.11n, Wi-Fi, and/or Bluetooth™ device that is capable of establishing wireless communication channel 936 between audio input device 920 and WAP 938. Display device 922 is shown wirelessly coupled to network 902 via wireless communication channel 940 established between display device 922 and WAP 942, which is shown directly coupled to network 902.

The various client electronic devices (e.g., client electronic devices 918, 920, 922, 924) may each execute an operating system, wherein the combination of the various client electronic devices (e.g., client electronic devices 918, 920, 922, 924) and computer system 900 may form modular system 944.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
identifying a target output token associated with an output of a machine learning model; and
modifying a portion of training data corresponding to the target output token with a watermark feature, thus defining watermarked training data.

2. The computer-implemented method of claim 1, wherein modifying the portion of training data includes:
identifying an existing portion of the training data corresponding to the target output token within the training data; and
modifying the existing portion of the training data corresponding to the target output token with the watermark feature.

3. The computer-implemented method of claim 1, wherein modifying the portion of training data includes:
adding a new portion of training data corresponding to the target output token with the watermark feature into the training data.

4. The computer-implemented method of claim 1, wherein the training data includes audio information with corresponding labeled text information for training a speech processing machine learning model.

5. The computer-implemented method of claim 4, wherein the target output token includes text output by the speech processing machine learning model in response to processing audio information.

6. The computer-implemented method of claim 1, wherein modifying the portion of training data includes:
adding a predefined acoustic watermark feature to the audio information training data corresponding to the target output token.

7. The computer-implemented method of claim 1, further comprising:
identifying a target machine learning model;
processing a first input dataset with watermarked data corresponding to the target output token using the target machine learning model to generate a first output dataset;
processing a second input dataset without watermarked data corresponding to the target output token using the target machine learning model to generate a second output dataset;
comparing modeling performance of the machine learning model for generating the first output dataset and the second output dataset;
determining whether the target machine learning model is trained using the watermarked training data based upon, at least in part, the modeling performance of the target machine learning model.

8. A computing system comprising:
a memory; and
a processor to determine a distribution of a plurality of acoustic features within training data, to modify the distribution of the plurality of acoustic features within the training data, thus defining watermarked training data, and to determine whether a target machine learning model is trained using the watermarked training data.

9. The computing system of claim 8, wherein the plurality of acoustic features are associated with a speech processing machine learning model.

10. The computing system of claim 9, wherein modifying the distribution of the plurality of acoustic features within the training data includes:
adding a noise signal to the training data.

11. The computing system of claim 9, wherein modifying the distribution of the plurality of acoustic features within the training data includes:
convolving the training data with an impulse response.

12. The computing system of claim 9, wherein the distribution of the plurality of acoustic features includes a distribution of Mel Filter-bank Coefficients.

13. The computing system of claim 8, wherein modifying the distribution of the plurality of acoustic features within the training data includes:
comparing the modified distribution of the plurality of acoustic features against a distribution modification threshold.

14. The computing system of claim 8, wherein determining whether the target machine learning model is trained using the watermarked training data:
processing a first input dataset with the modified distribution of the plurality of acoustic features using the target machine learning model to generate a first output dataset with the distribution of the plurality of acoustic features;
processing a second input dataset without the modified distribution of the plurality of acoustic features using the target machine learning model to generate a second output dataset without the distribution of the plurality of acoustic features;
comparing modeling performance of the target machine learning model for generating the first output dataset and the second output dataset; and
determining whether the target machine learning model is trained using the watermarked training data based upon, at least in part, the modeling performance of the target machine learning model.

15. A computer program product residing on a non-transitory computer readable medium having a plurality of instructions stored thereon which, when executed by a processor, cause the processor to perform operations comprising:
identifying a target machine learning model;
processing a first input dataset with watermarked data using the target machine learning model to generate a first output dataset;
processing a second input dataset without watermarked data using the target machine learning model to generate a second output dataset;
comparing modeling performance of the target machine learning model for generating the first output dataset and the second output dataset; and
determining whether the target machine learning model is trained using watermarked training data based upon, at least in part, the modeling performance of the target machine learning model.

16. The computer program product of claim 15, wherein the operations further comprise:
identifying a target output token associated with output of a machine learning model; and
modifying a portion of training data corresponding to the target output token with a watermark feature, thus defining watermarked training data.

17. The computer program product of claim 16, wherein processing the first input dataset includes:
processing the first input dataset with watermarked data corresponding to the target output token using the target machine learning model to generate the first output dataset.

18. The computer program product of claim 15, wherein the operations further comprise:
determining a distribution of a plurality of acoustic features within training data; and
modifying the distribution of the plurality of acoustic features within the training data, thus defining watermarked training data.

19. The computer program product of claim 18, wherein processing the first input dataset includes:
processing the first input dataset with the modified distribution of the plurality of acoustic features using the target machine learning model to generate the first output dataset with the distribution of the plurality of acoustic features.

20. The computer program product of claim 18, wherein determining whether the target machine learning model is trained using watermarked training data includes performing model inversion to verify that the target machine learning model is trained using watermarked training data.
